(19) United States
(12) Patent Application Publication
(10) Pub. No.: US 2025/0282184 A1
(43) Pub. Date: Sep. 11, 2025

(54) HIGH LOAD CAPACITY TIRE COMPRISING MOLDED ELEMENTS

(71) Applicant: COMPAGNIE GENERALE DES ETABLISSEMENTS MICHELIN, Clermont-Ferrand (FR)

(72) Inventors: CECILE GAGNAIRE, Clermont-Ferrand (FR); DAISUKE AOKI, Clermont-Ferrand (FR)

(21) Appl. No.: 18/855,885

(22) PCT Filed: Mar. 6, 2023
(86) PCT No.: PCT/EP2023/055621

§ 371 Date: Oct. 10, 2024

(30) Foreign Application Priority Data
Apr. 13, 2022 (FR) 2203391

(51) Int. Cl. B60C 15/00; B60C 9/02; B60C 13/00

(52) U.S. Cl. CPC B60C 15/0045; B60C 9/02; B60C 13/001; B60C 2009/0215; B60C 2013/006; B60C 2013/007; B60C 2200/04

(57) ABSTRACT

A tire of the high load capacity type for a passenger vehicle, comprises a smooth reference surface (44), and at least one molded recessed element (46) and/or at least one molded projecting element, recessed or projecting being with respect to the smooth reference surface (44). A maximum thickness Emax, the maximum depth Pmax of each molded recessed element (46) and/or the maximum height Hmax of each molded projecting element satisfy Emax\hat{ }(0.4)×Pmax≤1.1 and Emax\hat{ }(0.4)×Hmax≤1.1, Pmax and Hmax being expressed in mm. Emax is the maximum distance between the axially outermost reinforced layer (36) and the smooth reference surface (44). Emax is less than or equal to 3.0 mm.

The present invention relates to a tyre. The term “tyre” should be understood to mean a tyre casing intended to form a cavity by cooperating with a support element, for example a rim, this cavity being capable of being pressurized to a pressure greater than atmospheric pressure. A tyre according to the invention has a structure of substantially toroidal shape exhibiting symmetry of revolution about a main axis of the tyre.

The advent of electric or hybrid passenger vehicles is leading to an increase in the weight of the vehicles, notably on account of the batteries, the weight of which is relatively great and substantially proportional to the range (autonomy) of the vehicles. Thus, for example, in order to increase the range of an electric vehicle, it is necessary to increase the size of its batteries and, as a result, the weight of the vehicle.

Simply stated, it is currently estimated that one additional kilometre of range of an electric propulsion unit leads to the weight of the vehicle being increased by one kilogram. Thus, in order to achieve a range of 500 kilometres, it is necessary to increase the weight of a vehicle with combustion engine propulsion by approximately 500 kg. Such vehicles need to be fitted with tyres capable of bearing a very high load.

A passenger-vehicle tyre is known from the prior art, this tyre being capable of bearing a relatively high load. This tyre is marketed by MICHELIN™ in their Pilot Sport 4range and is of size 255/35R18. This tyre has an EXTRA LOAD (abbreviated to XL) version as defined by the ETRTO Standards Manual, 2019 and, in this EXTRA LOAD version, has a load index equal to 94. This means that, at a pressure of 290 kPa, the tyre is capable of carrying a load of 670 kg. This load-bearing capacity is relatively high compared to a tyre of the same size and designated as STANDARD LOAD (abbreviated to SL), having a load index equal to 90 and capable of carrying a load of 600 kg at a pressure of 250 kPa.

For such a tyre to be placed on the market, it must pass regulatory tests. For example, in Europe, the tyre needs to pass the load/speed performance test described at Annex VII of Regulation No. 30 of the Economic Commission for Europe of the United Nations (UN/ECE).

Nonetheless, even in its EXTRA LOAD version, and all the more so in its STANDARD LOAD version, such a tyre is incapable of bearing the additional load corresponding to the batteries needed to achieve the desired range. Thus, tyre manufacturers have had to offer new solutions in order to meet this new need.

One solution envisaged by tyre manufacturers is, for a given vehicle, the use of tyres of a larger size, which would be able to bear greater load. Thus, a given vehicle could be fitted with tyres having a higher load index. For example, a vehicle fitted with the tyres described above in their EXTRA LOAD version could be fitted with tyres of size 275/35R19 in their EXTRA LOAD version, which have a load index equal to 100 and are capable, at a pressure of 290 kPa, of bearing a load of 800 kg, much greater than the load of 670 kg.

On the one hand, such an increase in tyre size of necessity leads either to a reduction in the amount of vehicle interior space or to an increase in the exterior track width of the vehicle, neither of which is desirable for vehicle habitability and compactness reasons.

On the other hand, such an increase in tyre size necessitates a new vehicle chassis design which, for obvious cost reasons, is not desirable either.

Finally, such an increase in tyre size, notably in nominal section width, leads to an increase in the exterior noise generated by the tyre and to an increase in the rolling resistance, which is not desirable either when wishing to reduce the nuisance noise and the energy consumption of the vehicle.

Thus, another solution that tyre manufacturers have envisioned is, for a given size and a given version of a tyre, to increase the recommended inflation pressure thereof. Specifically, the higher the pressure, the more capable the tyre is of bearing a high load.

Nevertheless, the use of a relatively high recommended pressure increases the stiffness of the tyre and leads to a loss of comfort for the passengers of the vehicle, and this is obviously not desirable to certain motor vehicle manufacturers in instances in which passenger comfort takes priority over the load that can be borne.

Thus, tyre manufacturers have decided to create a new type of tyre. This new type is now known under the designation HIGH LOAD CAPACITY in the ETRTO Standards Manual, 2021. This new type of tyre makes it possible to guarantee that the load that the tyre of a given size is capable of bearing is higher than that which a tyre of the same size, but in its EXTRA LOAD version, would be capable of bearing. For the 255/35R18 size, the tyre of the HIGH LOAD CAPACITY type thus has a load index equal to 98, indicating that it is capable, at a pressure of 290 kPa, of bearing a load of 750 kg.

It has been observed, when using these HIGH LOAD CAPACITY tyres, that cracks begin at the surface of the sidewalls of these tyres, notably in a radially upper portion comprised radially between, on the one hand, the equator of the tyre and, on the other hand, a normal to the internal surface passing through a circumferential demarcation line marking the division between the sidewall and the crown. It has been noted that these cracks appear particularly when driving over a deep hole in the roadway or over a significant bump in the roadway, when sharply mounting a curb, when using a pressure significantly lower than the recommended pressure, or else when the tyre is used under a load that is significantly higher than the maximum load.

Such cracks, while not dangerous to the user of the tyre, are detrimental to the external appearance of the tyre and therefore to its aesthetic appeal. Furthermore, they may cause the user of the tyre unnecessary worry.

It is an object of the invention to provide a tyre capable of bearing a greater load than the existing tyres while at the same time reducing, or even eliminating, the risk of cracking on the sidewall.

Thus, the subject of the invention is a tyre for a passenger vehicle, comprising a crown, two beads, two sidewalls connecting each bead to the crown, at least one of the sidewalls comprising at least one reinforced layer comprising reinforcing elements embedded in a polymer matrix, the or each sidewall comprising a radially upper portion comprised radially between:
the equator of the tyre, and
a normal to the interior surface passing through a circumferential demarcation line marking the division between the sidewall and the crown, the radially upper portion having an exterior face comprising:
a smooth reference surface,
at least one moulded recessed element and/or at least one moulded projecting element, recessed or projecting being with respect to the smooth reference surface, the tyre (10) being of the HIGH LOAD CAPACITY type according to the ETRTO Standards Manual, 2021,
   a maximum thickness Emax, a maximum depth Pmax of the or each moulded recessed element of the radially upper portion with respect to the smooth reference surface and/or a maximum height Hmax of the or each moulded projecting element of the radially upper portion with respect to the smooth reference surface satisfy Emax(0.4) x Pmax ≤ 1.1 and Emax\hat{ }(0.4)×Hmax≤1.1, Emax, Pmax and Hmax being expressed in mm, where Emax is the maximum distance, measured in the radially upper portion along a straight line normal to the interior surface, between:
the axially exterior surface that passes through the axially outermost point of each reinforcing element of the or each portion of the or each axially outermost reinforced layer in the radially upper portion, and
the smooth reference surface,
   Emax is less than or equal to 3.0.

According to the invention, the tyre is a tyre for a passenger vehicle. Such a tyre is for example defined in the ETRTO (European Tyre and Rim Technical Organisation) Standards Manual, 2021. Such a tyre generally has, on at least one of the sidewalls, a marking conforming to the marking in the ETRTO Standards Manual, 2021 indicating the size of the tyre in the form X/Y α V U β where X denotes the nominal section width, Y denotes the nominal aspect ratio, a denotes the structure and may be R or ZR, V denotes the nominal rim diameter, U denotes the load index and β denotes the speed symbol.

By increasing the load index of the tyre of the invention relative to the load index of a tyre of the same size in its EXTRA LOAD version, the invention makes it possible to increase the load-bearing capacity of the tyre-wheel assembly without modifying the roominess, compactness and comfort of the vehicle on which it is used. Specifically, since the size of the tyre according to the invention is identical to that of the tyre in its EXTRA LOAD version, the tyre-wheel assembly does not take up any more space than the tyre in its EXTRA LOAD version. A tyre of the invention may bear distinctive markings so that it can be differentiated from its STANDARD LOAD version and from its EXTRA LOAD version, for example a marking of the HL (HIGH LOAD) or XL+(EXTRA LOAD+) type. Such a marking is disclosed in particular in the ETRTO Standards Manual, 2021, on page 3 of the section General Notes—Passenger Car Tyres. Examples of sizes of tyres of the HIGH LOAD CAPACITY type are also disclosed in the ETRTO Standards Manual, 2021 on page 44, paragraph 9.1 in the section Passenger Car Tyres-Tyres with Metric Designation.

A tyre of the HIGH LOAD CAPACITY type may be characterized by its load index LI such that LI≥LI′+1, and LI′ being the load index of an EXTRA LOAD tyre of the same size in accordance with the ETRTO Standards Manual, 2021. The load index LI′ is the load index of an EXTRA LOAD tyre of the same size, namely of the same nominal section width, the same nominal aspect ratio, the same structure (R and ZR being considered to be identical) and the same nominal rim diameter. The load index LI′ is given in the ETRTO Standards Manual, 2021, notably in the part entitled “Passenger Car Tyres—Tyres with Metric Designation”, pages 22 to 43. LI=LI′+1, or LI=LI′+2, or LI=LI′+3 or else LI=LI′+4, depending on the size. In most embodiments, LI′+1≤LI≤LI′+4, and even LI′+2≤LI≤LI′+4.

The inventors behind the invention have understood that, because of the relatively high load that tyres of the HIGH LOAD CAPACITY type have had to bear, the radially upper portion of the sidewall has been subject to very high stresses, notably during highly stressful events as described hereinabove. This radially upper portion comprises that portion of the exterior face of the sidewall that, during highly stressful events, will have the smallest radius of curvature and therefore a high stress concentration. This portion of the exterior face of the sidewall can easily be determined, for example by inflating the tyre to a pressure less than or equal to its nominal pressure and subjecting it to a load significantly higher than the nominal load, for example to a load greater than or equal to 120% of its nominal load, the pressure and the nominal load being those indicated in the ETRTO Standards Manual, 2021.

The inventors have also understood that these extremely high stresses are localized to the vicinity of those zones of the sidewall that locally exhibit a very great variation in thickness.

The inventors have thus determined that, by reducing these local variations in thickness which are essentially present in the vicinity of the recessed or protruding moulded elements present on the exterior face of the radially exterior portion, for example in the form of markings, the risk of cracking in the sidewall is reduced or even eliminated.

The inventors have also observed that the greater the maximum thickness Emax of the tyres of the HIGH LOAD CAPACITY type, the more sensitive the sidewalls were to the appearance of the cracks described hereinabove. Thus, the inventors have determined a relationship to make it possible either to limit the maximum depth Pmax or the maximum height Hmax of the moulded elements for a given maximum thickness Emax, or to limit the maximum thickness Emax for a given maximum depth Pmax and/or given maximum height Hmax of the moulded elements.

In addition to satisfying the relationship determined by the inventors, the maximum thickness Emax will be reduced as far as possible in order to reduce the risk of cracking since, as explained hereinabove, the higher the maximum thickness Emax, the higher this risk is.

The recessed or projecting moulded elements notably comprise markings, vent

spew hairs and/or vent spew holes and are preferably selected from among these elements. The markings notably comprise regulatory markings, decorative markings, and tyre monitoring markings, and are preferably selected from among these elements. The regulatory markings comprise notably the regulatory markings required by the various regulations and notably comprise the make of the tyre, its commercial designation and the DOT number. The decorative markings comprise markings the purpose of which is essentially to embellish the exterior appearance of the tyre. The tyre monitoring markings notably comprise coded matrix symbols (QR codes).

The vent spew hairs are elements that are moulded as projections having a slender shape and resulting from the spewing of the elastomer composition bearing the exterior surface of the tyre into the vents of a mould while the tyre is being moulded. Similarly, the vent spew holes are elements that are moulded as recesses with the overall shape of a well once the tyre has been moulded.

The circumferential demarcation line marking the division between the sidewall and the crown is generally a moulded line because it corresponds to the division between two mould elements used for moulding the sidewall and for moulding the crown. When several circumferential lines are present, the circumferential demarcation line is the radially innermost circumferential line. In the absence of a moulded line, the demarcation line marking the division between the sidewall and the crown is an imaginary circumferential line situated at:
a radial distance equal to 65% of the sidewall height H of the tyre measured from the radially interior end of the tyre, in the case of tyres for which H<95,
a radial distance equal to 70% of the sidewall height H of the tyre measured from the radially interior end of the tyre, in the case of tyres for which H≥95.

The sidewall height H is defined by H=SW×AR/100, where SW is the nominal section width and AR the nominal aspect ratio of the tyre, for example as indicated in the ETRTO Standards Manual, 2021.

The smooth surface is that surface of the tyre that has no recessed or protruding moulded elements and that follows the curvature of the exterior face of the tyre without any abrupt local variation. This smooth surface serves as a reference for determining the maximum depth Pmax and/or the maximum height Hmax. Thus, the smooth reference surface is the entity formed by the smooth surface that passes through that surface of the tyre that does not have recessed or protruding moulded elements and by an imaginary surface that follows the curvature of the exterior face of the tyre and forms a continuous continuation of the smooth surface discounting the recessed or protruding moulded elements. The smooth nature of the reference surface characterizes the fact that the reference surface has a roughness that is very much lower than that of a moulded element and in any event a roughness indetectable to human touch. The smooth reference surface is generally characterized by a lightness very much greater than the lightness of the moulded element which itself needs to contrast with this smooth reference surface.

What is meant by a moulded element is an element formed as one material with the rest of the sidewall of the tyre during the moulding of the tyre. Each recessed or protruding moulded element is continuous. Thus, as soon as two recessed elements or two protruding elements are at least partially touching and connected to one another by an element that is likewise recessed or protruding, these recessed or protruding elements will be considered to be all joined together and to form just one and the same single recessed or protruding moulded element. By contrast, as soon as two recessed elements or two protruding elements are completely disconnected from one another and are separated from one another by part of the smooth reference surface, these two recessed elements or two protruding elements will be considered to be two distinct moulded elements.

The maximum depth Pmax of the recessed moulded element considered is the maximum value of the distances measured between the smooth reference surface and the various points in the bottom of the recessed moulded element concerned. Similarly, the maximum height Hmax of the protruding moulded element considered is the maximum value of the distances measured between the smooth reference surface and the various points on the exterior surface of the projecting moulded element concerned.

As a preference, the radially upper portion extends circumferentially continuously over the entire circumference of the tyre.

Other recessed or protruding moulded elements may be present on the sidewall of the tyre, outside of the radially upper portion. It is possible for these other moulded elements not to obey the relationship determined by the inventors. Specifically, because the stresses outside of the radially upper portion are not as high, the risk of cracking is lower, or even non-existent.

The maximum thickness Emax of the radially upper portion is the maximum value of the thicknesses of the radially upper portion, it being possible for the thickness to be constant or variable.

For the or each reinforced layer of the sidewall or sidewalls, a continuous surface, referred to as the axially exterior surface (SAE) of said layer, passing through the axially outermost point of each reinforcing element, and a continuous surface, referred to as the axially interior surface (SAI) of said layer, passing through the axially innermost point of each reinforcing element, are defined.

In some embodiments, the radially upper portion comprises the one same single axially outermost reinforced layer over the entirety of the radial height of the radially upper portion. In other embodiments, the radially upper portion comprises several reinforced layers that are axially outermost depending on the radially heightwise point on the radially upper portion. In these other embodiments, the axially exterior surface SAE used for calculating the maximum distance Emax is the axially exterior surface of each portion of each reinforced layer that is axially outermost at the radially heightwise point at which the thickness between the axially exterior surface and the smooth surface is measured.

The expression “reinforcing element” means an element providing mechanical reinforcement to the polymer matrix in which this reinforcing element is intended to be embedded.

Preferably, the reinforcing element is filamentary, which means to say that the reinforcing element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

The matrix is said to be polymeric because it is based on a polymeric composition, this polymeric composition possibly comprising one or more polymers, for example selected from thermoplastic polymers, thermosetting polymers, elastomers, thermoplastic elastomers, and also fillers and other components usually used in the field of compositions for tyres, in particular compositions for embedding reinforcing elements.

The interior surface delimits the interior cavity of the tyre. The interior cavity is intended to be pressurized with the inflation gas once the tyre has been mounted on a mounting support, for example a rim.

The exterior surface is the surface of the tyre in contact with air at atmospheric pressure and visible from the outside of the tyre.

The tyre according to the invention has a substantially toroidal shape about an axis of revolution substantially coinciding with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, i.e. the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential surface of the tyre” means the combination of the planes passing, in each meridian section plane, through the equator (denoted E) of the tyre and perpendicular to the median plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread that is intended to be in contact with the ground, and the radially innermost point of the tyre that is intended to be in contact with a support, for example a rim, the distance between these two points being equal to H.

The expression “meridian plane” means a plane parallel to and containing the axis of rotation of the tyre and perpendicular to the circumferential direction.

The expressions “radially inner/interior/inside” and “radially outer/exterior/outside” mean closer to the axis of rotation of the tyre and further away from the axis of rotation of the tyre, respectively. The expressions “axially inner/interior/inside” and “axially outer/exterior/outside” mean closer to the median plane of the tyre and further away from the median plane of the tyre, respectively.

A bead means that portion of the tyre that is intended to allow the tyre to be secured to a mounting support, for example a wheel comprising a rim. Thus, each bead is notably intended to be in contact with a flange of the rim allowing it to be attached.

Any interval of values denoted by the expression “between a and b” represents the range of values extending from more than a to less than b (which is to say, excluding the end-points a and b), whereas any interval of values denoted by the expression “from a to b” means the range of values extending from a up to b (which is to say, including the strict end-points a and b).

In embodiments making it possible to reduce the risk of cracking, the radially upper portion bearing the exterior face comprises one or a plurality of recessed moulded element(s) and/or one or a plurality of protruding moulded element(s), the or at least some of the plurality of recessed moulded element(s) or the or at least some of the plurality of projecting moulded element(s) is/are such that Emax\hat{ }(0.4)×Pmax≤1.1 and Emax\hat{ }(0.4)×Hmax≤1.1. In these embodiments, the invention is applied to just some of the moulded elements in the radially upper portion.

In embodiments making it possible to reduce the risk of cracking still further, the radially upper portion bearing the exterior face comprises one or a plurality of recessed moulded element(s) and/or one or a plurality of protruding moulded element(s), the or all of the plurality of recessed moulded element(s) or the or all of the plurality of projecting moulded element(s) is/are such that Emax\hat{ }(0.4)×Pmax≤1.1 and Emax\hat{ }(0.4)×Hmax≤1.1. In these embodiments, the invention is applied to all of the moulded elements in the radially upper part.

In certain embodiments making it possible to reduce the risk of cracking, bearing in mind the relatively small size of the vent spew hairs and the vent spew holes, the recessed and/or projecting moulded elements to which the invention relates are the recessed and/or projecting moulded elements except for the vent spew hairs and the vent spew holes.

In some embodiments, the recessed and/or projecting moulded elements to which the invention relates comprise the recessed and/or projecting moulded elements comprising lines oriented in the circumferential direction. What is meant here by lines is lines that delimit the recessed and/or projecting moulded elements. Thus, a letter is delimited by several lines oriented in different directions, one or more of these lines being oriented in the circumferential direction. Other examples include markings in the form of striations that may be oriented in the circumferential direction.

In advantageous embodiments that make it possible to limit the risk of cracking, Emax\hat{ }(0.4)×Pmax≤0 0.9 and Emax\hat{ }(0.4)×Hmax≤0 0.9, more preferentially Emax\hat{ }(0.4)×Pmax≤0 0.8 and Emax\hat{ }(0.4)×Hmax≤0 0.8, and more preferentially still, Emax×Pmax≤0 0.6 and Emax×Hmax≤0 0.6.

The tyres are intended for passenger vehicles as defined in the ETRTO Standards Manual, 2021. Such a tyre has a section in a meridian section plane that is characterized by a section height H and a nominal section width S within the meaning of the ETRTO Standards Manual, 2021, such that, optionally, the aspect ratio H/S, expressed as a percentage, is at most equal to 90 and is at least equal to 20, and the nominal section width S is at least equal to 225 mm and at most equal to 385 mm. Furthermore, the diameter D at the flange, which defines the diameter of the rim on which the tyre is mounted, is optionally at least equal to 16 inches and at most equal to 24 inches. Finally, and still optionally, the load index LI ranges from 98 to 116.

In some advantageous embodiments making it possible to limit the risk of cracking, the radially upper portion of said or of each sidewall comprises an elastomer composition bearing the exterior surface of said radially upper portion of said sidewall and having a modulus at 10% extension less than or equal to 10 MPa, preferably less than or equal to 5 MPa, and more preferentially ranging from 1 MPa to 5 MPa. Preference will be given to elastomer compositions where, the higher the risk of the tyre cracking, the lower the modulus at 10% extension.

The elastomeric composition bearing the exterior surface identifies the elastomeric composition in contact with air at atmospheric pressure and visible from the outside of the tyre. Thus, in the embodiments in which the radially upper portion of the sidewall comprises several elastomeric compositions arranged axially one next to the other, it is the modulus at 10% extension of the axially outermost composition bearing the exterior surface that is characterized.

The elastomeric composition bearing the exterior surface is based on one or several elastomer(s). It may also comprise fillers and other components usually used in the field of compositions for tyres.

Concerning the modulus at 10% extension, commonly referred to as MA10, this is the elastic modulus of the compound measured during uniaxial tensile testing, at an elongation value of 0.1 (i.e. 10% elongation, expressed as a percentage). The uniaxial tension is applied to the test specimen at a constant rate, and the elongation and the force are measured. The measurements are taken using an INSTRON type tensile tester, at a temperature of 23° C., and a relative humidity of 50% (standard ISO 23529). The conditions for measuring and for exploiting the results in order to determine elongation and stress are as described in the standard NF ISO 37:2012-03. The stress is determined for an elongation of 0.1 and the modulus of elasticity under tension at 10% elongation is calculated by determining the ratio of this stress value to the elongation value. A person skilled in the art will know how to choose and adapt the dimensions of the test specimen according to the quantity of compound accessible and available in particular in the case of test specimens taken from the tyre.

In some optional embodiments, Pmax is less than or equal to 0.8 mm, preferably less than or equal to 0.5 mm and Hmax is less than or equal to 0.8 mm, preferably less than or equal to 0.5 mm. In addition to satisfying the relationship determined by the inventors, the maximum depth Pmax and/or the maximum height Hmax will preferably be reduced as far as possible in order to eliminate any risk of cracking.

In some embodiments which are advantageous but nevertheless optional, Pmax is greater than or equal to 0.3 mm, and Hmax is greater than or equal to 0.3 mm. Because the contrast between the moulded elements is all the greater the greater the maximum depth Pmax and/or the greater the maximum height Hmax, preference will be given to a sufficient maximum depth Pmax and/or maximum height Hmax.

In some embodiments which are advantageous but nevertheless optional, Emax is greater than or equal to 1.0 mm, and preferably ranges from 1.5 mm to 2.5 mm.

Advantageously, the tyre has a sidewall height H defined by H=SW×AR/100 where SW is the nominal section width and AR is the nominal aspect ratio of the tyre, a load index LI satisfying 0.72≤H/LI≤0.95, preferably 0.72≤H/LI≤0.90, where SW, AR and LI are defined in accordance with the ETRTO Standards Manual, 2021. Thus, the invention is preferably applied to tyres that are likely to have relatively significant deflection because they have a relatively high load index for a sidewall height that is relatively low for this load index. Specifically, in such cases, the radially exterior portion of the sidewall forms a relatively short hinge experiencing a great deal of bending, notably in the highly stressful situations described hereinabove, and which are therefore very susceptible to the appearance of cracking.

The nominal section width SW, the nominal aspect ratio AR, and the load index LI are notably indicated by the size marking inscribed on the sidewall of the tyre and in accordance with the ETRTO Standards Manual, 2021.

In a first configuration, the tyre comprises a carcass reinforcement comprising at least one carcass layer anchored in each bead, the crown comprising a crown reinforcement, the carcass layer anchored in each bead extending radially in each sidewall and axially in the crown radially to the inside of the crown reinforcement, the or each portion of the or each axially outermost reinforced layer being formed by at least one portion of that carcass layer anchored in each bead that is axially outermost in the radially upper portion.

In a first variant of the first configuration, the carcass reinforcement comprises a single carcass layer anchored in each bead.

In certain embodiments of this first variant, the carcass layer anchored in each bead is wound around a circumferential reinforcing element of each bead, so that an axially interior portion of the carcass layer anchored in each bead is arranged axially to the inside of an axially exterior portion of the carcass layer anchored in each bead and so that each axial end of the carcass layer anchored in each bead is arranged radially to the outside of each circumferential reinforcing element:
the or each portion of the or each axially outermost reinforced layer is formed by at least a portion of the axially interior portion in the radially upper portion, and/or
the or each portion of the or each axially outermost reinforced layer is formed by at least a portion of the axially exterior portion in the radially upper portion.

In other embodiments of this first variant, each bead comprises an axially interior circumferential reinforcing element arranged axially to the inside of the carcass layer and an axially exterior circumferential reinforcing element arranged axially to the outside of the carcass layer, for example as described in WO 2021/123522.

In a second variant of the first configuration, the carcass reinforcement comprises a first and second carcass layers anchored in each bead.

In certain embodiments of this second variant, the first carcass layer is wound around a circumferential reinforcing element of each bead such that an axially interior portion of the first carcass layer is arranged axially to the inside of an axially exterior portion of the first carcass layer and such that each axial end of the first carcass layer is arranged radially to the outside of each circumferential reinforcing element, and each axial end of the second carcass layer is arranged radially to the inside of each axial end of the first layer.

In a first variant of these embodiments, each axial end of the second carcass layer is arranged axially between the axially interior and exterior portions of the first carcass layer, the or each portion of the or each axially outermost reinforced layer being formed by at least a portion of the second carcass layer in the radially upper portion. In this first variant, the second carcass layer is arranged radially to the outside of the first carcass layer in the crown.

In a second variant of these embodiments, each axial end of the second carcass layer is arranged axially to the inside of each axially interior portion of the first carcass layer, the or each portion of the or each axially outermost reinforced layer being formed by at least a portion of the first carcass layer in the radially upper portion. In this variant, the second carcass layer is arranged radially to the inside of the first carcass layer in the crown and axially to the inside of the first carcass layer in each sidewall.

In a third variant of these embodiments, each axial end of the second carcass layer is arranged axially to the outside of each axially exterior portion of the first carcass layer, the or each portion of the or each axially outermost reinforced layer being formed by at least a portion of the second carcass layer in the radially upper portion. In this variant, the second carcass layer is arranged radially to the outside of the first carcass layer in the crown and axially to the outside of the first carcass layer in each sidewall.

In other embodiments of this second variant, each bead comprises a plurality of circumferential reinforcing elements, at least a portion of each first and second carcass layer being arranged axially between at least two circumferential reinforcing elements of the plurality of circumferential reinforcing elements, for example as described in WO2021/123522.

In a second configuration, the tyre comprises:
a carcass reinforcement comprising at least one carcass layer anchored in each bead, the crown comprising a crown reinforcement, the carcass layer anchored in each bead extending radially in each sidewall and axially in the crown radially to the inside of the crown reinforcement,
a sidewall reinforcing layer arranged axially to the outside of the carcass reinforcement, the or each portion of the or each axially outermost reinforced layer being formed by at least a portion of the sidewall reinforcing layer in the radially upper portion.

Unlike a carcass layer which is anchored in each bead, the sidewall reinforcing layer is not anchored in each bead. Thus, each radially interior end of the sidewall reinforcing layer is arranged radially to the outside of each bead. The sidewall reinforcing layer extends at least radially in each sidewall and has:
a radially interior end arranged radially to the inside of the equator of the tyre, and
a radially exterior end arranged radially to the outside of the equator of the tyre.

In certain embodiments in which the carcass layer or the first carcass layer forms a winding, each axial end of said carcass layer is arranged radially to the inside of the equator of the tyre and even more preferably arranged at a radial distance of less than or equal to mm from a radially interior end of each circumferential reinforcing element of each bead. By arranging each axial end of the carcass layer or of the first carcass layer to the inside of the equator of the tyre, the mass of the carcass reinforcement is significantly reduced. Furthermore, the vast majority of rims currently used for passenger vehicle tyres have J-type rim flanges of which the height is, in all cases, less than 30 mm. The highly preferential arranging of each axial end in a zone substantially radially corresponding to the rim flange enables this axial end to be mechanically protected. Specifically, if each axial end were arranged radially too high above each circumferential reinforcing element of each bead, namely at a radial distance strictly greater than 30 mm from the radially interior end of each circumferential reinforcing element, each axial end would then be situated in a flexible zone of the tyre which zone is subjected to excessively high stresses, which stresses are particularly high in the case of a tyre of HIGH LOAD CAPACITY type.

In other embodiments in which the carcass layer or the first carcass layer forms a winding, each axial end of said carcass layer is arranged radially to the outside of the equator of the tyre. Advantageously, in these other embodiments, each axial end of the carcass layer or of the first carcass layer is highly preferentially arranged axially to the inside of an axial end of the or of at least one of the crown layer(s) of the crown reinforcement.

Optionally, the or each carcass layer anchored in each bead is axially delimited by two axial ends of said carcass layer and comprises carcass reinforcing elements extending axially from one axial end to the other axial end of the carcass layer.

Optionally, each carcass reinforcing element extends in a main direction forming an

angle with the circumferential direction of the tyre which, in terms of absolute value, is greater than or equal to 60°, preferably ranging from 80° to 90°.

In some embodiments, the crown comprises a crown reinforcement comprising a working reinforcement comprising a radially interior working layer and a radially exterior working layer arranged radially to the outside of the radially interior working layer.

Optionally, each working layer is axially delimited by two axial ends of said working layer and comprises working reinforcing elements extending axially from one axial end to the other axial end of said working layer, substantially parallel to one another.

Optionally, each working reinforcing element extends along a main direction forming an angle with the circumferential direction of the tyre which, in terms of absolute value, is strictly greater than 10°, preferably ranging from 15° to 50° and more preferably ranging from 20° to 35°.

As a preference, in the embodiments in which the working reinforcement comprises a radially innermost working layer and a radially outermost working layer arranged radially to the outside of the radially innermost layer, the main direction along which each working reinforcing element of the radially innermost working layer extends and the main direction along which each working reinforcing element of the radially outermost working layer extends form oppositely oriented angles with the circumferential direction of the tyre.

Optionally, the crown reinforcement comprises a hoop reinforcement axially delimited by two axial ends of the hoop reinforcement and comprising at least one hooping reinforcing element wound circumferentially in a helix so as to extend axially between the axial ends of the hoop reinforcement.

As a preference, the hoop reinforcement is arranged radially to the outside of the working reinforcement.

As a preference, the or each hooping reinforcing element extends in a main direction forming an angle with the circumferential direction of the tyre which, in terms of absolute value, is less than or equal than 10°, preferably less than or equal to 7° and more preferentially less than or equal to 5°.

As a preference, the or each carcass, working and hooping reinforcing element is a filamentary reinforcing element.

In advantageous embodiments, the or each recessed moulded element and/or the or each projecting moulded element has a lightness L*1 ranging from 6 to 15 and preferably ranging from 8 to 10, and the smooth reference surface has a lightness L*2, greater than or equal to 18 and preferably ranging from 18 to 30. These advantageous embodiments make it possible to obtain a relatively high level of contrast even in instances in which the maximum depth Pmax and/or the maximum height Hmax is relatively small. Specifically, in general, and all other factors being equal, the smaller the maximum depth Pmax and/or the maximum height Hmax, the lower the contrast between the moulded element and the smooth reference surface.

Thus, in this way, it is ensured that the moulded element is in strong contrast with the smooth reference surface. What is meant by “lightness” is the parameter that characterizes the capacity of a circuit to reflect light. Lightness is expressed here using a scale that ranges from 0 to 100 in accordance with the L*a*b* colour model adopted in 1976 by the International Commission on Illumination (CIE). The value 100 represents white or total reflection; the value 0 represents black or total absorption. The lightness values L*1 and L*2 are determined using a spectrocolorimeter, for example a KONICA-MINOLTA CM 700D spectrocolorimeter. This appliance is positioned over the region of which the lightness is to be measured, and the lightness of this region is measured directly. This measurement is taken notably using the SCI (specular component included) mode, set at an angle of 10° and with a D65 type light setting (setting as defined by the CIE). In order to improve the determination of the lightness L*2, it is possible to take a plurality of measurements on the tyre and deduce a mean lightness of the smooth reference surface therefrom.

In some advantageous embodiments, the or each recessed moulded element and/or the or each projecting moulded element has a texture comprising a plurality of elements projecting with respect to the bottom of said recessed moulded element and/or of said projecting moulded element.

Optionally, the projecting elements of the plurality of projecting elements are independent individual elements spread through the texture at a density at least equal to one element per square millimetre. In a variant, the plurality of projecting elements comprises strands, each strand having a mean cross section comprised between 0.003 mm2 and 1 mm2. Examples of strands are described for example in EP1954463, EP2204296 or else EP2483088. In another variant, the plurality of projecting elements comprises bumps as found on Dunlop tyres marketed under the designation V EURO. In other variants, the plurality of projecting elements comprises stars as found on Bridgestone tyres marketed under the designation POTENZA SPORT.

Optionally, the protruding elements of the plurality of protruding elements are substantially mutually parallel lamellae, the spacing of the lamellae in the texture being at most equal to 0.5 mm, each lamella having a mean width of between 0.03 mm and 0.25 mm. Examples of lamellae are described for example in EP2483088 and WO2012/131089.

The invention will be more clearly understood upon reading the description below, which is provided purely as a non-limiting example, with reference to the figures in which:

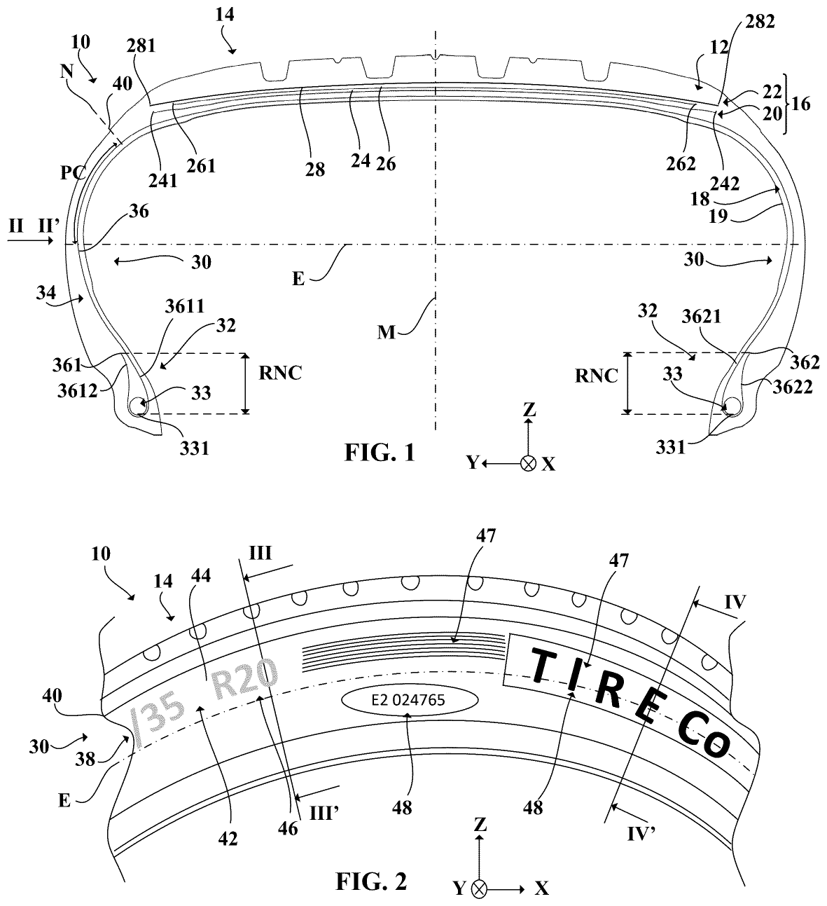

FIG. 1 is a view, in a meridian plane of section, of a tyre according to a first embodiment of the invention;

FIG. 2 is a side view of an exterior face of the tyre of FIG. 1 in the direction II-Il′ indicated in FIG. 1;

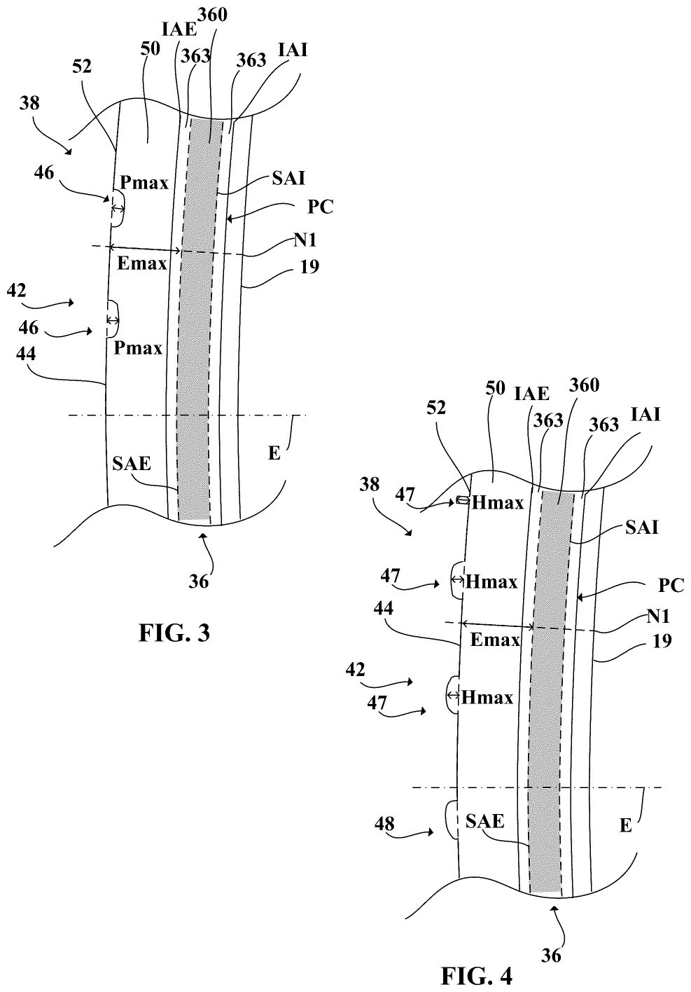

FIGS. 3 and 4 are detailed views, respectively on meridian planes of section III-III′ and IV-IV′ indicated in FIG. 2, illustrating a radially exterior portion of the sidewall of the tyre of FIG. 1; and

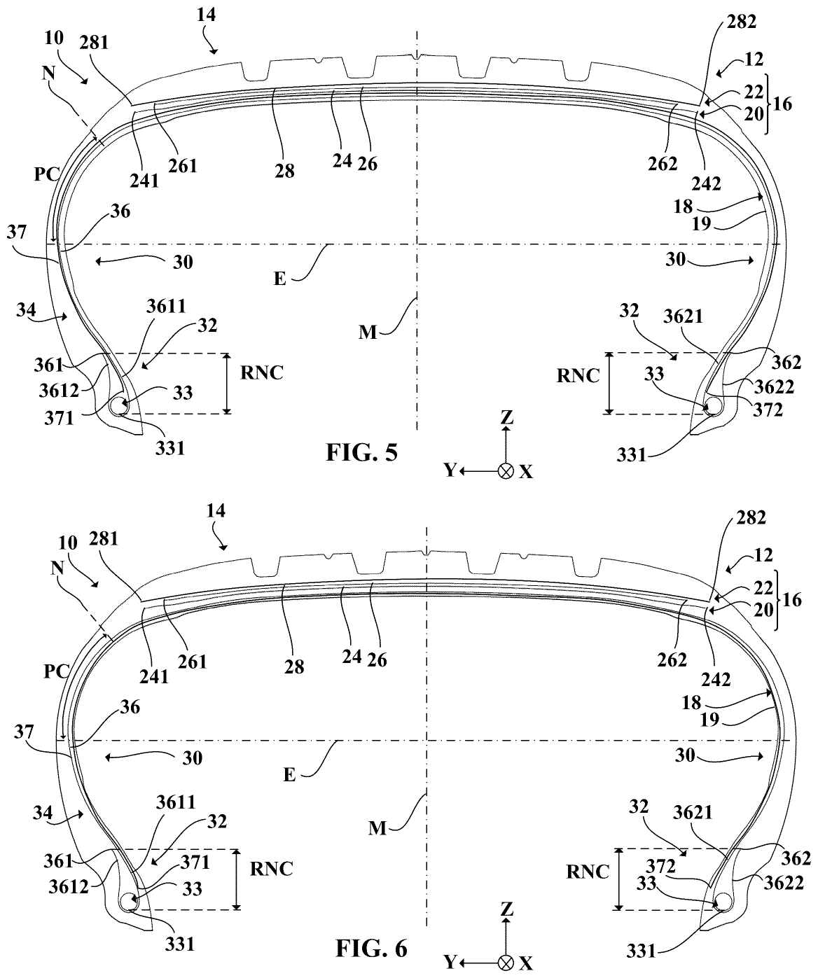

FIGS. 5 to 9 are views similar to that of FIG. 1, of tyres according to second, third, fourth, fifth and sixth embodiments respectively.

A frame of reference X, Y, Z corresponding to the usual axial (Y), radial (Z) and circumferential (X) directions, respectively, of a tyre or a tyre-wheel assembly is shown in the figures.

FIG. 1 shows a tyre according to the invention, denoted by the general reference 10. The tyre 10 has a substantially toroidal shape about an axis of revolution substantially parallel to the axial direction Y. The tyre 10 is intended for a passenger vehicle and has dimensions 255/35 R20. In the various figures, the tyre 10 is shown as new, i.e., when it has not yet been run.

The tyre 10 comprises a crown 12 comprising a tread 14 intended to come into contact with the ground when it is running and a crown reinforcement 16 extending in the crown 12 in the circumferential direction X. The tyre 10 also comprises an airtight inner-liner 18 which is impervious to an inflation gas and is intended to delimit, with a support on which the tyre 10 is mounted, an interior cavity once the tyre 10 has been mounted on the mounting support, for example a rim, this cavity being intended to be pressurized by the inflation gas. The airtight inner-liner 18 carries an interior surface 19 of the tyre 10.

The crown reinforcement 16 comprises a working reinforcement 20 and a hoop reinforcement 22. The working reinforcement 20 comprises at least one working layer and, in this instance, two working layers comprising a radially interior working layer 24 and a radially exterior working layer 26 arranged radially to the outside of the radially interior working layer 24.

The hoop reinforcement 22 comprises at least one hooping layer and in this instance comprises one hooping layer 28.

The crown reinforcement 16 is arranged radially to the inside of the tread 14. In this instance, the hoop reinforcement 22, in this case the hooping layer 28, is arranged radially to the outside of the working reinforcement 20 and is therefore interposed radially between the working reinforcement 20 and the tread 14.

The tyre 10 comprises two sidewalls 30 that continue the crown 12 radially towards the inside. The tyre 10 also comprises two beads 32 radially to the inside of the sidewalls 30. Each sidewall 30 connects each bead 32 to the crown 12.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12 radially to the inside of the crown reinforcement 16.

The carcass layer 36 anchored in each bead 32 is wound around a circumferential reinforcing element 33 of each bead 32, so that an axially interior portion 3611, 3621 of the carcass layer 36 anchored in each bead 32 is arranged axially to the inside of an axially exterior portion 3612, 3622 of the carcass layer 36 anchored in each bead 32 and so that each axial end 361, 362 axially delimiting the carcass layer 36 anchored in each bead 32 is arranged radially to the outside of each circumferential reinforcing element 33. Each axial end 361, 362 of the carcass layer 36 anchored in each bead 32 is arranged radially to the inside of the equator E of the tyre. More precisely, each axial end 361, 362 of the carcass layer 36 anchored in each bead 32 is arranged at a radial distance RNC less than or equal to 30 mm from a radially interior end 331 of each circumferential reinforcing element 33 of each bead 32. In this case, RNC=23 mm.

Each working layer 24, 26, hooping layer 28 and carcass layer 36 comprises a polymeric matrix, in this case an elastomeric matrix, in which are embedded one or more reinforcing elements of the corresponding layer, in this case filamentary reinforcing elements. Each filamentary hooping reinforcing element, working reinforcing element and carcass reinforcing element is, for example, identical to those described in application WO2021250331A1.

The hoop reinforcement 22, here the hooping layer 28, is delimited axially by two axial ends 281, 282. The hoop reinforcement 22 comprises one or more filamentary hooping reinforcing elements wound circumferentially in a helix so as to extend axially from one axial end to the other of the hoop reinforcement 22 in a main direction DO forming an angle AF with the circumferential direction X of the tyre 10 which, in terms of absolute value, is less than or equal to 10°, preferably less than or equal to 7° and more preferably less than or equal to 5°. In this case, AF=−5°

The radially interior working layer 24 is delimited axially by two axial ends 241, 242. The radially interior working layer 24 comprises filamentary working reinforcing elements extending axially from one axial end to the other substantially parallel to each other in a main direction D1. Similarly, the radially exterior working layer 26 is delimited axially by two axial ends 261, 262. The radially exterior working layer 26 comprises filamentary working reinforcing elements extending axially from one axial end to the other, substantially parallel to one another in a main direction D2. Each main direction D1, D2 forms, with the circumferential direction X of the tyre 10, respective angles AT1 and AT2 of opposite orientations. Each main direction D1, D2 respectively forms, with the circumferential direction X of the tyre 10, an angle AT1, AT2 which, in terms of absolute value, is strictly greater than 10°, preferably ranging from 15° to 50° and more preferentially ranging from 20° to 35°. In this case, AT1=−26° and AT2=+26°.

The carcass layer 36 comprises filamentary carcass reinforcing elements extending axially from one axial end to the other in a main direction D3 forming, with the circumferential direction X of the tyre 10, an angle AC, which, in terms of absolute value, is greater than or equal to 60°, preferably ranging from 80° to 90°, and in this case AC=+90°.

Each sidewall 30 bears a marking indicating the size of the tyre 10, and also a speed rating and a speed code. In the present instance, the tyre 10 has a nominal section width SW equal to 255, a nominal aspect ratio AR equal to 35, and a nominal rim diameter equal to 20. The tyre 10 therefore has a sidewall height H defined by SW×AR/100 which in this case is equal to 89. In accordance with the invention, the marking also comprises a load index LI such that LI≥LI′+1, where LI′ is the load index of an EXTRA LOAD tyre of the same size according to the ETRTO Standards Manual, 2019. Preferably, LI′+1≤LI≤LI′+4, and even LI′+2≤LI≤LI′+4. A tyre of size 255/35R20 in its EXTRA LOAD version has a load index equal to 97, as indicated on page 36 of the section Passenger Car Tyres—Tyres with Metric Designation of the ETRTO Standards Manual, 2019. Thus, the load index LI of the tyre 10 is such that LI≥98, preferably 98≤LI≤101 and even 99≤LI≤101, and in this case LI=100. This load index equal to 100 corresponds to the load index of a HIGH LOAD CAPACITY tyre of size 255/35R20, as indicated in the ETRTO Standards Manual, 2021. Thus, the tyre 10 is indeed of the HIGH LOAD CAPACITY type.

The tyre 10 is such that 0.72≤H/LI≤0.95, preferably 0.72≤H/LI≤0.90, and in this case H/LI=0.89.

With reference to FIGS. 1 to 4, each sidewall 30 comprises a radially upper portion 38 comprised radially between the equator E of the tyre and a normal N to the interior surface 19, passing through a circumferential demarcation line 40 marking the division between each sidewall 30 and the crown 12. The radially upper portion 38 bears an exterior face 42 visible in FIG. 2 comprising a smooth reference surface 44 and recessed moulded elements 46 and projecting moulded elements 47. In the example illustrated in FIG. 2, the recessed moulded elements 46 comprise a regulatory marking “R20”38 and the projecting moulded elements 47 comprise a “TIRE Co.” marking and a decorative marking in the form of striations comprising lines oriented in the circumferential direction.

Each sidewall 30 also comprises moulded elements 48 are arranged outside of the exterior face 42 of the radially upper portion 38.

As illustrated in FIGS. 3 and 4, the radially upper portion 38 comprises an elastomer composition 50 bearing the external surface 52 of the radially upper portion 38. The elastomer composition 50 has a modulus MA10 at 10% extension less than or equal to 10 MPa, preferably less than or equal to 5 MPa, and more preferentially ranging from 1 MPa to 5 MPa. In this case, MA10=3 MPa. Examples of compositions compatible with these MA10 modulus values are the control composition T1 of WO2019/097175, comparative example A described in WO2018/100080, the compositions described in WO2018/091841 and WO2019/229323.

Each sidewall 30 comprises a reinforced layer comprising reinforcing elements embedded in a polymer matrix, in this instance the carcass layer 36 comprising the carcass reinforcing elements 360 embedded in a polymer matrix 363. The carcass layer 36 comprises an axially exterior surface SAE passing through the axially outermost point of each carcass reinforcing element 360, and an axially interior surface SAI passing through the axially innermost point of each carcass reinforcing element 360. The carcass layer 36 is separated from the adjacent compositions with which its polymer matrix 363 is in contact by axially interior and axially exterior interfaces IAI and IAE respectively.

At any point on the interior surface 19 of the radially upper portion 38, a thickness EP is measured along a straight line N1 normal to the interior surface 19 at that point. The thickness EP is the distance measured along each normal straight line N1 between, on the one hand, the axially exterior surface SAE of a portion PC of the axially outermost reinforced layer in the radially upper portion 38, in this instance a portion PC of the axially interior portion 3611 of the carcass layer 36 in the radially upper portion 38 and, on the other hand, the smooth reference surface 44. The maximum value for the thicknesses measured in the radially upper portion 38 is the maximum thickness Emax. Emax is less than or equal to 3.0 mm and greater than or equal to 1.0 mm, and preferably ranges from 1.5 mm to 2.5 mm. In this case, Emax=2.4 mm.

With reference to FIG. 3, the recessed moulded element 46 has a maximum depth Pmax with respect to the smooth reference surface 44. Pmax is less than or equal to 0.8 mm, preferably less than or equal to 0.5 mm, and greater than or equal to 0.3 mm. In this case Pmax=0.5 mm.

With reference to FIG. 4, each projecting moulded element 47 has a maximum height Hmax with respect to the smooth reference surface 44. Hmax is less than or equal to 0.8 mm, preferably less than or equal to 0.5 mm, and greater than or equal to 0.3 mm. In this case, Hmax=0.5 mm.

Thus, Pmax, Hmax and Emax satisfy Emax\hat{ }(0.4)×Pmax≤1.1 and Emax\hat{ }(0.4)×Hmax≤1.1, preferably Emax\hat{ }(0.4)×Pmax≤0.9 and Emax\hat{ }(0.4)×Hmax≤0.9, and more preferentially, Emax\hat{ }(0.4)×Pmax≤0.8 and Emax\hat{ }(0.4)×Hmax≤0.8. In this case, Emax\hat{ }(0.4)×Hmax=Emax\hat{ }(0.4)×Pmax=0.7. In other embodiments, Emax and/or Hmax and Pmax may be reduced so that Emax\hat{ }(0.4)×Pmax≤0.6 and Emax\hat{ }(0.4)×Hmax≤0.6.

Tyres according to second, third, fourth, fifth and sixth embodiments of the invention will now be described with reference to FIGS. 5 to 9 respectively. Elements that are analogous to those shown in the preceding figures are designated by identical references.

Unlike the tyre according to the first embodiment, the carcass reinforcement 36 of the tyre 10 according to the second embodiment of FIG. 5 comprises first and second carcass layers 36, 37 anchored in each bead 32. The first carcass layer 36 is wound around a circumferential reinforcing element 33 of each bead 32, so that an axially interior portion 3611, 3621 of the first carcass layer 36 is arranged axially to the inside of an axially exterior portion 3612, 3622 of the first carcass layer 36, and so that each axial end 361, 362 of the first carcass layer 36 is arranged radially to the outside of each circumferential reinforcing element 33. Each axial end 371, 372 of the second carcass layer 37 is arranged radially to the inside of each axial end of the first layer 361, 362 and is arranged axially between the axially interior and exterior portions 3611, 3612 and 3621, 3622 of the first carcass layer 36. In this second embodiment, the portion PC of the axially outermost reinforced layer is formed by a portion PC of the second carcass layer 37 in the radially upper portion 38.

Unlike the tyre according to the second embodiment, in the tyre 10 according to the third embodiment illustrated in FIG. 6, each axial end 371, 372 of the second carcass layer 37 is arranged axially to the inside of each axially interior portion 3611, 3621 of the first carcass layer 36. In this third embodiment, the portion PC of the axially outermost reinforced layer is formed by the portion PC of the first carcass layer 36 in the radially upper portion 38.

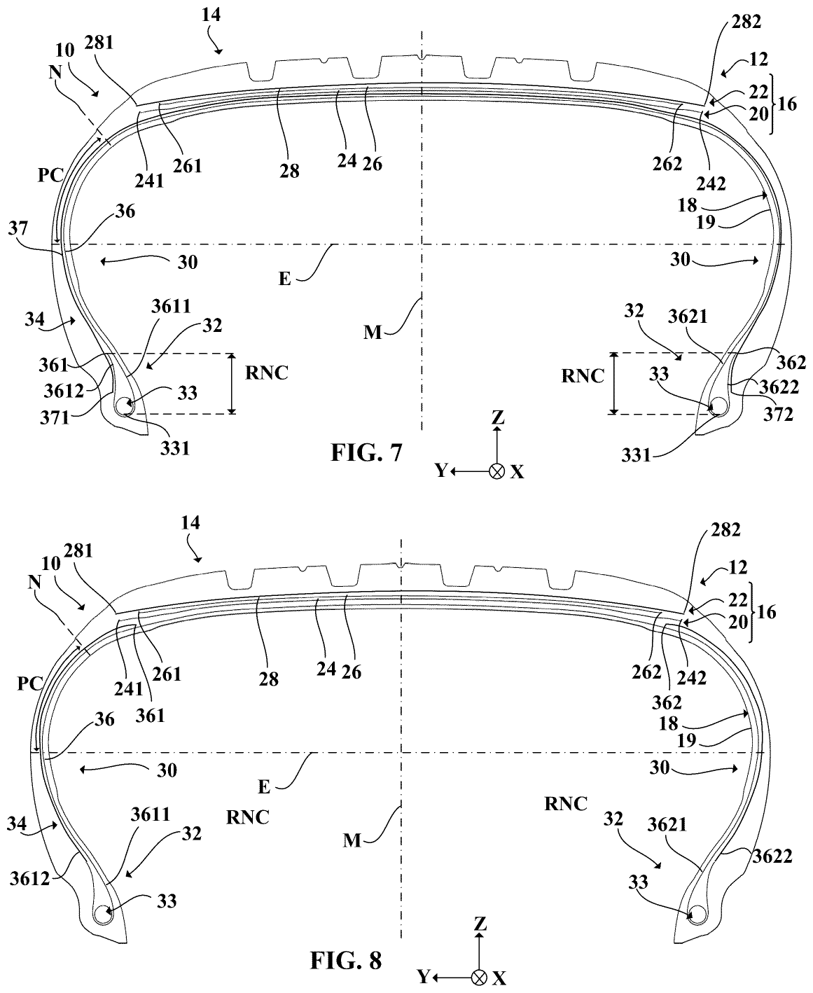

Unlike the tyre according to the second embodiment, in the tyre 10 according to the fourth embodiment illustrated in FIG. 7, each axial end 371, 372 of the second carcass layer 37 is arranged axially to the outside of each axially exterior portion 3612, 3622 of the first carcass layer 36. In this fourth embodiment, the portion PC of the axially outermost reinforced layer is formed by the portion PC of the second carcass layer 37 in the radially upper portion 38.

Unlike the tyre according to the first embodiment, in the tyre 10 according to the fifth embodiment illustrated in FIG. 8, each axial end 361, 362 of the carcass layer 36 anchored in each bead and wound to form a turnup is arranged radially to the outside of the equator E and even more preferably arranged axially to the inside of the axial ends 141, 281 of the working layer 24 and hooping layer 28 of the crown reinforcement 16. In this fifth embodiment, the portion PC of the axially outermost reinforced layer is formed by the portion PC of the axially outermost portion 3612 of the carcass layer 36 in the radially upper portion 38.

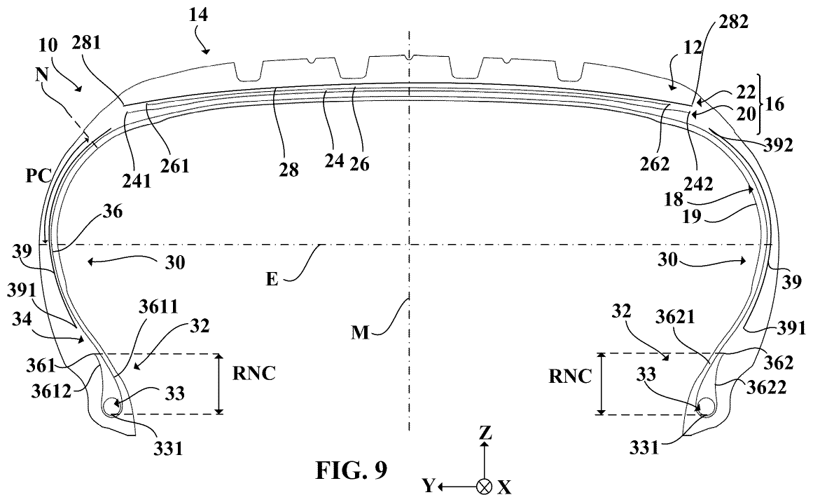

Unlike the tyre according to the first embodiment, in the tyre 10 according to the sixth embodiment illustrated in FIG. 9, in addition to the carcass reinforcement 34, the tyre 10 comprises two sidewall reinforcing layers 39 arranged axially to the outside of the carcass reinforcement 34. Each sidewall reinforcing layer 39 extends at least radially in each sidewall 30 and has a radially interior end 391 arranged radially to the inside of the equator E and a radially exterior end 392 arranged radially to the outside of the equator E. Each radially interior end 391 of each sidewall reinforcing layer 39 is arranged radially to the outside of each bead 32 and is therefore not anchored to this bead.

### COMPARATIVE TESTS

Different tyres inflated to a nominal pressure and subjected to a load significantly greater than the nominal load stated in the ETRTO Standards Manual, 2021 were run in a load/speed performance test described at Annex VII to Regulation No. 30 of the Economic Commission for Europe of the United Nations (UN/ECE).

A first control tyre of size HL 255/35 R20, not in accordance with the invention, had a thickness Emax=3.1 mm and recessed and protruding moulded elements of maximum depth Pmax and maximum height Emax both equal to 0.8 mm. At the end of the test, this first tyre had cracks in the radially upper portion of at least one of the sidewalls.

A second tyre of size HL 255/35 R20, in accordance with the invention, had a thickness Emax=2.4 mm and recessed and protruding moulded elements of maximum depth Pmax and maximum height Emax both equal to 0.8 mm. At the end of the test, this tyre in accordance with the invention exhibited no cracks.

The invention is not limited to the above-described embodiments.

1.-14. (canceled)

15. A tire for a passenger vehicle, comprising a crown, two beads, and two sidewalls connecting each bead to the crown,
at least one of the sidewalls comprising at least one reinforced layer comprising reinforcing elements embedded in a polymer matrix, the at least one sidewall comprising a radially upper portion comprised radially between:
an equator of the tire, and
a normal to an interior surface passing through a circumferential demarcation line marking a division between the at least one sidewall and the crown,
the radially upper portion having an exterior face comprising:
a smooth reference surface, and
at least one molded recessed element and/or at least one molded projecting element, recessed or projecting with respect to the smooth reference surface,
wherein the tire is a high load capacity tire according to ETRTO Standards Manual, 2021,
wherein a maximum thickness Emax, a maximum depth Pmax of the at least one molded recessed element of the radially upper portion with respect to the smooth reference surface and/or a maximum height Hmax of the at least one molded projecting element of the radially upper portion with respect to the smooth reference surface satisfy Emax\hat{ }(0.4)×Pmax≤1.1 and Emax\hat{ }(0.4)×Hmax≤1.1, Emax, Pmax and Hmax being expressed in mm,
where Emax is a maximum distance, measured in the radially upper portion along a straight line normal to the interior surface between:
an axially exterior surface that passes through an axially outermost point of each reinforcing element of at least one portion of at least one axially outermost reinforced layer in the radially upper portion, and
the smooth reference surface, and
Emax is less than or equal to 3.0 mm.

16. The tire according to claim 15, wherein Emax\hat{ }(0.4)×Pmax≤0.9 and Emax\hat{ }(0.4)×Hmax≤0.9.

17. The tire according to claim 15, wherein the radially upper portion of the at least one sidewall comprises an elastomer composition bearing an exterior surface of the radially upper portion of the at least one sidewall and having a modulus at 10% extension less than or equal to 10 MPa.

18. The tire according to claim 15, wherein Pmax is less than or equal to 0.8 mm.

19. The tire according to claim 15, wherein Pmax is greater than or equal to 0.3 mm, and Hmax is greater than or equal to 0.3 mm.

20. The tire according to claim 15, wherein Emax is greater than or equal to 1.0 mm.

21. The tire according to claim 15, wherein the tire has a sidewall height H defined by H=SW×AR/100, where SW is a nominal section width and AR is a nominal aspect ratio of the tire, and the tire has a load index LI satisfying 0.72≤H/LI≤0.95, where SW, AR and LI are defined in accordance with ETRTO Standards Manual, 2021.

22. The tire according to claim 15, further comprising a carcass reinforcement comprising at least one carcass layer anchored in each bead, the crown comprising a crown reinforcement, the at least one carcass layer anchored in each bead extending radially in each sidewall and axially in the crown radially to an inside of the crown reinforcement, the at least one portion of the at least one axially outermost reinforced layer being formed by at least one portion of the at least one carcass layer anchored in each bead that is axially outermost in the radially upper portion.

23. The tire according to claim 22, wherein the carcass reinforcement comprises a single carcass layer anchored in each bead.

24. The tire according to claim 23, wherein the single carcass layer anchored in each bead is wound around a circumferential reinforcing element of each bead, so that an axially interior portion of the single carcass layer anchored in each bead is arranged axially to an inside of an axially exterior portion of the single carcass layer anchored in each bead and so that each axial end of the single carcass layer anchored in each bead is arranged radially to an outside of each circumferential reinforcing element,
wherein the at least one portion of the at least one axially outermost reinforced layer is formed by at least a portion of an axially interior portion in the radially upper portion, and/or
wherein the at least one portion of the at least one axially outermost reinforced layer is formed by at least a portion of an axially exterior portion in the radially upper portion.

25. The tire according to claim 22, wherein the carcass reinforcement comprises first and second carcass layers anchored in each bead.

26. The tire according to claim 25, wherein the first carcass layer is wound around a circumferential reinforcing element of each bead such that an axially interior portion of the first carcass layer is arranged axially to an inside of an axially exterior portion of the first carcass layer and such that each axial end of the first carcass layer is arranged radially to an outside of each circumferential reinforcing element, and each axial end of the second carcass layer is arranged radially to an inside of each axial end of the first layer, and:
axially between the axially interior portions and exterior portions of the first carcass layer, the at least one portion of the at least one axially outermost reinforced layer is formed by at least one portion of the second carcass layer in the radially upper portion, or
axially to an inside of each axially interior portion of the first carcass layer, the at least one portion of the at least one axially outermost reinforced layer is formed by at least one portion of the first carcass layer in the radially upper portion, or
axially to an outside of each axially exterior portion of the first carcass layer, the at least one portion of the at least one axially outermost reinforced layer is formed by at least one portion of the second carcass layer in the radially upper portion.

27. The tire according to claim 15, further comprising:
a carcass reinforcement comprising at least one carcass layer anchored in each bead, the crown comprising a crown reinforcement, the at least one carcass layer anchored in each bead extending radially in each sidewall and axially in the crown radially to an inside of the crown reinforcement, and
a sidewall reinforcing layer arranged axially to an outside of the carcass reinforcement,
the at least one portion of the at least one axially outermost reinforced layer being formed by at least a portion of the sidewall reinforcing layer in the radially upper portion.

28. The tire according to claim 15, wherein the at least one molded recessed element and/or the at least one molded protruding element has a lightness L*1, ranging from 6 to 15, and wherein the smooth reference surface has a lightness L*2, greater than or equal to 18.
